(19) United States
(12) Patent Application Publication
(10) Pub. No.: US 2026/0285749 A1
(43) Pub. Date: Sep. 24, 2026

(54) PLANT AND METHOD FOR BURNING CARBONATE ROCK

(71) Applicant: Scheuch Management Holding GmbH, Aurolzmünster (AT)

(72) Inventors: Georg LECHNER, Schildorn (AT); Patrick OBERMÜLLER, Utzenaich (AT); Stefan HUEMER, Schärding (AT); Thomas FELLNER, Neukirchen an der Enknach (AT)

(21) Appl. No.: 19/475,669

(22) PCT Filed: Apr. 19, 2024
(86) PCT No.: PCT/EP2024/060770

§ 371 Date: Oct. 15, 2025

(30) Foreign Application Priority Data
Apr. 21, 2023 (EP) 23169277.3

(51) Int. Cl. C04B 2/12; B01D 53/76; B01D 53/86; F27B 1/22

(52) U.S. Cl. CPC C04B 2/12; B01D 53/76; B01D 53/8625; F27B 1/22; B01D 2257/404; B01D 2258/0283

(57) ABSTRACT

Plant and method for burning carbonate rock, comprising: a lime shaft kiln with a first kiln shaft and a second kiln shaft, which are operated alternately as a burning shaft for burning raw material and as a preheating shaft for preheating raw material, and with a crossover channel between the first and the second kiln shaft, via which exhaust gases can be transferred from the burning shaft to the preheating shaft, an exhaust gas discharge for discharging exhaust gases from the lime shaft kiln, and an exhaust gas cleaning stage for cleaning the exhaust gases discharged from the lime shaft kiln. The exhaust gas cleaning stage buffers fluctuations in the temperature of the exhaust gases from the lime shaft kiln and comprises at least one regenerator for regenerative heat exchange with the exhaust gases discharged from the lime shaft kiln.

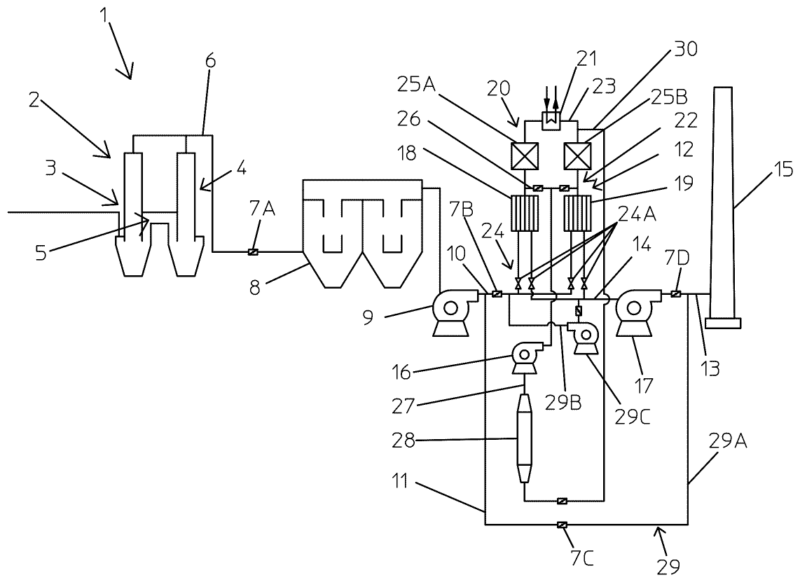

### CROSS REFERENCE TO RELATED APPLICATIONS

The present application is a U.S. National Phase of International Application No. PCT/EP2024/060770 entitled “SYSTEM AND METHOD FOR BURNING CARBONATE ROCK,” and filed on Apr. 19, 2024. International Application No. PCT/EP2024/060770 claims priority to European Patent Application No. 23169277.3 filed on Apr. 21, 2023. The entire contents of each of the above-listed applications are hereby incorporated by reference for all purposes.

### TECHNICAL FIELD

The invention relates to a plant and a method for burning carbonate rock.

### BACKGROUND AND SUMMARY

Various methods for burning carbonate rock, in particular limestone, are known in the prior art. On the one hand, there are continuous methods in which, for example, a rotary kiln is used. On the other hand, there are also discontinuous methods, in which mostly a lime shaft kiln is employed. A particularly common design of a lime shaft kiln is the parallel flow regenerative lime kiln (PFR lime kiln).

In general, a lime shaft kiln comprises at least one stationary kiln shaft for burning carbonate rock, which essentially does not move during the burning operation. Preferably, several such kiln shafts are implemented. A lime shaft kiln operates discontinuously, meaning that the carbonate rock is fed in batch by batch. Due to the discontinuous mode of operation, a renewed heating process of the carbonate rock takes place with each new batch, which, among other things, can be reflected in a periodically varying exhaust gas temperature and periodically varying exhaust gas values.

From EP 2 478 314 B1, a parallel flow regenerative lime kiln (PFR lime kiln) for burning limestone is known. The PFR lime kiln consists of at least two shafts, each of which comprises a preheating zone, a burning zone, and a cooling zone. Both shafts are connected to each other via a crossover channel. The material to be burned is fed from above into both shafts and withdrawn at the bottom as burned material. The shafts are operated alternately as a burning shaft and an exhaust gas shaft, wherein combustion air and fuel are supplied to the burning shaft in co-current with the material, and the resulting hot exhaust gases, together with the heated cooling air supplied from below, are directed via the crossover channel into the exhaust gas shaft, where the exhaust gases are led upward in counter-current to the material and thereby preheat the material. After a predetermined time span, for example 15 minutes, the function of the two shafts is reversed, i.e., the burning shaft becomes the exhaust gas shaft and vice versa. This method allows very efficient burning of the limestone in co-current with the combustion gases and a regenerative preheating of the limestone in counter-current to the hot exhaust gases.

DE 10 2021 204176 A1 discloses a plant for the production of quicklime by the oxyfuel process. The described plant comprises, in addition to a PFR kiln and a filter, a regenerative heat exchanger, which transfers heat from a cooling gas to an exhaust gas to be recirculated into the kiln.

US 2020/048146 A1 discloses another lime shaft kiln that can be operated using the oxyfuel process. Several regenerative heat exchangers are provided for preheating the combustion air by means of the heat of the dedusted exhaust gas.

Furthermore, EP 3 631 329 B1 discloses a method by which the nitrogen oxides can be removed from the exhaust gases of the PFR kiln. EP 3 631 329 B1 provides a solution in which the exhaust gases are specifically heated by a heater to the temperatures necessary for catalytic denitrification, then an ammonia solution is introduced into the exhaust gases, and afterward, the exhaust gases are fed to a catalytic filter that accomplishes filtration and SCR conversion of the exhaust gases. Subsequently, the exhaust gases are conveyed through a stack line via a fan and finally discharged into the environment through a stack.

However, because of the fluctuating exhaust gas temperatures, the known method disadvantageously requires a complex control of the heating. Since the NOₓ concentration in the exhaust gas is also subject to strong fluctuations, the injection of ammonia must also be controlled accordingly in order to ensure both the most complete possible reduction of nitrogen oxides and the lowest possible ammonia slip. For this purpose, the measured values recorded by various temperature, pollutant, and flow rate measuring sensors are used, on the one hand, to control the temperature of the exhaust gas before the catalytic filter by means of the heater and, on the other hand, to control the amount of ammonia solution supplied by a dosing system.

In addition, a large variety of alternative cleaning technologies for industrial exhaust gases are known in the prior art, but these have so far not been adapted to the special features of the lime shaft kiln, in particular the PFR kiln, especially to the fluctuating exhaust gas temperatures.

It is therefore an object of the present invention to develop a method tailored to the cleaning of exhaust gases of a lime shaft kiln, preferably a PFR kiln, and a plant equipped therewith, with which the disadvantages occurring in the prior art are at least alleviated or avoided.

This object is achieved by a plant and a method as described herein.

Thus, the plant according to the invention for burning carbonate rock to the corresponding oxides, preferably limestone (i.e., a sedimentary rock consisting predominantly of calcium carbonate CaCO₃) to quicklime (calcium oxide CaO), comprises at least:
a lime shaft kiln with at least one kiln shaft, preferably a parallel flow regenerative (PFR) kiln with a first kiln shaft and a second kiln shaft, which are operated alternately as a burning shaft for burning raw material and as a preheating shaft for preheating raw material, and with a crossover channel between the first and the second kiln shaft, via which exhaust gases are transferred from the burning shaft to the preheating shaft,
an exhaust gas discharge for discharging exhaust gases from the lime shaft kiln, preferably the PFR kiln,
an exhaust gas cleaning stage for cleaning the exhaust gases discharged from the lime shaft kiln, preferably from the PFR kiln, wherein the exhaust gas cleaning stage, for buffering fluctuations in the temperature of the exhaust gases from the lime shaft kiln, preferably the PFR kiln, comprises at least one regenerator for regenerative heat exchange with the exhaust gases discharged from the lime shaft kiln, preferably from the PFR kiln.

In the method according to the invention for burning carbonate rock, preferably limestone to quicklime, at least the following steps are carried out:
Operating a lime shaft kiln with at least one kiln shaft, with which raw material is burned,
Discharging exhaust gases from the lime shaft kiln,
Cleaning, in particular denitrifying, the exhaust gases discharged from the lime shaft kiln with a cleaning stage 12,
Regenerative heat exchange between the exhaust gases discharged from the lime shaft kiln and a regenerator 18, whereby temperature fluctuations of the exhaust gases discharged from the lime shaft kiln are buffered.

In a particularly preferred embodiment, in the method according to the invention for burning carbonate rock, preferably limestone to quicklime, at least the following steps are carried out:
Operating a parallel flow regenerative (PFR) kiln in a first operating state, in which raw material is burned with a first kiln shaft of the PFR kiln and raw material is preheated with a second kiln shaft of the PFR kiln, wherein exhaust gases are transferred from the first kiln shaft to the second kiln shaft,
Operating the PFR kiln in a second operating state, in which raw material is burned with the second kiln shaft and raw material is preheated with the first kiln shaft, wherein exhaust gases are transferred from the second kiln shaft to the first kiln shaft,
Discharging exhaust gases from the PFR kiln, in particular from the second kiln shaft in the first operating state and from the first kiln shaft in the second operating state,
Cleaning, in particular denitrifying, the exhaust gases discharged from the PFR kiln with a cleaning stage,
Regenerative heat exchange between the exhaust gases discharged from the PFR kiln and a regenerator, whereby temperature fluctuations of the exhaust gases discharged from the PFR kiln occurring in the first and/or second operating state of the PFR kiln are buffered.

For the purposes of this disclosure, the indications of position and direction, such as “above,” “below,” “horizontal,” “vertical,” refer to the intended state of use of the plant.

Due to the periodic heating processes of the carbonate rock in the lime shaft kiln, periodic fluctuations in volume flow, temperature, and pollutant concentrations of the exhaust gases drawn off from the respective kiln shaft occur.

Due to the regular switching between the first and second operating states of a PFR kiln, periodic fluctuations in volume flow, temperature, and pollutant concentrations of the exhaust gases drawn off from the respective preheating shaft or exhaust gas shaft occur.

When discharged from the lime shaft kiln, preferably from the PFR kiln, the exhaust gases can comprise an average temperature of about 130° C. In the cleaning stage, the exhaust gases are cleaned. If the cleaning stage comprises an SCR unit, the exhaust gases must be brought to a temperature of 280 to 420° C., for example essentially to 350° C., for the selective catalytic reduction (SCR) of nitrogen oxides (NOₓ).

According to the invention, the exhaust gas cleaning stage comprises at least the regenerator (i.e., a heat exchanger having a heat storage mass serving as a short-term heat accumulator), which exchanges heat regeneratively with the exhaust gases discharged from the lime shaft kiln, preferably from the PFR kiln, before the exhaust gases are cleaned. Preferably, the regenerator comprises a ceramic material as heat storage mass. According to the prior art, EP 3 631 329 B1, the process-related temperature fluctuations of the kiln exhaust gas must be compensated in their entirety by a complex control of the heating in order to ensure a somewhat constant temperature in the SCR catalyst and thus uniform denitrification. According to the invention, these rapidly occurring fluctuations in exhaust gas temperature are buffered by the regenerative heat exchange of the exhaust gases with the regenerator. Similar to capacitors in an electrical circuit, which have the property of smoothing out current peaks, the heat storage mass of the regenerator exerts a rectifying effect on the temperature profile in one (or more) denitrification catalysts of the cleaning stage in the case of SCR of the exhaust gases and correspondingly damps temperature fluctuations and peaks. This effect occurs not only in regenerative SCR but also in regenerative thermal or catalytic oxidation (RTO or RCO) of the exhaust gases downstream of the lime shaft kiln, preferably downstream of the PFR kiln. In these applications as well, the inertia of the heat storage mass in the regenerator significantly attenuates the fluctuations in the temperature profile. As a result, it is advantageously possible to relieve a (described below) heating device with which the exhaust gases can be heated.

In a particularly preferred embodiment, at least one recirculation line is provided for recirculating at least part of the exhaust gases from the clean gas side to the raw gas side of the cleaning stage, in particular during the charging of a kiln shaft of the lime shaft kiln, preferably the first and/or second kiln shaft of the PFR kiln, with raw material.

If the lime shaft kiln is operated in a charging operating state, a kiln shaft of the lime shaft kiln can be charged with raw material.

If the PFR kiln is operated (preferably in a time between the first and second operating states) in a charging operating state, the first and/or the second kiln shaft of the PFR kiln can be charged with raw material.

Over the duration of the charging operating state, the volume flow of the exhaust gases discharged from the lime shaft kiln, preferably from the PFR kiln, into the cleaning stage can be at least reduced, in particular essentially interrupted, preferably by switching off a gas conveying device, in particular a fan. During the charging operating state, it is advantageous if at least part of the exhaust gases, in particular all the exhaust gases, are recirculated from the clean gas side to the raw gas side of the cleaning stage, i.e., returned for renewed flow through the cleaning stage. If SCR of the exhaust gases is carried out with the cleaning stage, then immediately after the end of the charging operating state, the exhaust gas from the lime shaft kiln, preferably from the PFR kiln, may arrive with the maximum NOₓ load, so that in the prior art a strong heating of the exhaust gases along with very rapid control is required to be able to bring the denitrification catalyst immediately to the necessary temperature for effective denitrification of the exhaust gases. If this temperature is not reached in the prior art, besides increased NOₓ and NH₃ emissions, deposits of ammonium sulfate ((NH₄)₂SO₄) might form in the denitrification catalyst, which would reduce its life span. The recirculation from the clean gas side to the raw gas side (i.e., returning the cleaned clean gas from the cleaning stage for renewed flow through the cleaning stage) makes it possible, on the other hand, to keep a denitrification catalyst of the cleaning stage at the ideal temperature for denitrification during the charging operating state. If significant heat losses occur in this process, they can be compensated by heating of the recirculated exhaust gas. Furthermore, any excess NH₃ can also be recirculated with the clean gas and thus has time to react in the catalyst, which can reduce NH₃ slip. When, after the end of the charging operating state, (more) exhaust gas with an increased NOₓ load arrives again from the lime shaft kiln, preferably from the PFR kiln, into the cleaning stage, the exhaust gas experiences a beneficial dilution effect due to the recirculation.

In one embodiment, the recirculation line is formed by a bypass line to bypass the cleaning stage, wherein the bypass line is branched off from the exhaust gas discharge and routed back into a stack line upstream of a stack for discharging the exhaust gases to the surroundings of the plant. This embodiment has the particular advantage that a bypass line to bypass the cleaning stage must be provided anyway, in order to route the exhaust gases selectively past the cleaning stage to the stack line via the bypass line and to discharge them to the environment through the stack, for example when starting up the cleaning stage. This bypass line can be used in recirculation mode to route the exhaust gases after flowing through the cleaning stage from the stack line back into the exhaust gas discharge via the bypass line, after which the exhaust gases pass through the cleaning stage once again. This recirculation can be repeated as often as desired. In recirculation mode, the exhaust gases flow through the bypass line in the opposite direction as in bypass mode.

In another embodiment, a recirculation line is routed from an outlet line of the cleaning stage back to an inlet line of the cleaning stage. In this embodiment, the recirculation line departs from the outlet line of the cleaning stage upstream of the branch-off of the bypass line from the stack line and rejoins the inlet line of the cleaning stage downstream of the branch-off of the bypass line from the exhaust gas discharge. This embodiment has the advantage that the recirculation line can be kept particularly short, which can more reliably avoid possible problems that could arise from using the bypass line for the exhaust gas recirculation, such as damage or corrosion of the bypass line due to the temperature of the exhaust gas falling below the dew point. Furthermore, a uniform flow through the cleaning stage can be ensured. This embodiment of the recirculation line is particularly suitable in combination with an electric heating device of the cleaning stage, which—unlike a gas-fired heater—does not require the supply of fresh air.

Depending on the design, two recirculation lines can also be provided, one of which is formed by the bypass line and the other of which is routed from the outlet line of the cleaning stage back to the inlet line of the cleaning stage.

The advantages of the regenerative heat exchange of the exhaust gases from the lime shaft kiln, preferably the PFR kiln, can be utilized in various designs of the cleaning stage. The cleaning stage preferably comprises an SCR (selective catalytic reduction) unit and/or an RTO (regenerative thermal oxidation) unit and/or an RCO (regenerative catalytic oxidation) unit. Thus, the cleaning stage can in particular carry out SCR, RTO, and/or RCO of the exhaust gases discharged from the lime shaft kiln, preferably from the PFR kiln. These designs are themselves known in the prior art. The cleaning stage therefore preferably comprises at least one catalyst, in particular a denitrification catalyst and/or an oxidation catalyst.

In a preferred embodiment, the cleaning stage comprises a first channel with the regenerator, a connecting space, in particular a head space, and a second channel with another regenerator, and a control system is provided for flow through the cleaning stage in alternating directions. In this embodiment, depending on the switching state of the control system, the exhaust gases discharged from the lime shaft kiln, preferably from the PFR kiln, flow in a first operating mode in one direction and in a second operating mode in the opposite direction through the cleaning stage. Preferably, the first channel comprises a first catalyst, in particular a denitrification catalyst and/or an oxidation catalyst, and the second channel comprises a second catalyst, in particular a further denitrification catalyst and/or a further oxidation catalyst.

Preferably, the connecting space is designed as a head space, which is arranged at an angle other than 0 and 180 degrees, in particular substantially at a right angle, to the first and second channels. As a result, the raw gas inlet and the clean gas outlet are arranged in spatial proximity to each other. Preferably, the first and the second channels are arranged essentially vertically and the head space essentially horizontally. Depending on the design, a third, and in particular also a fourth and a fifth channel, can be provided, which is connected via the connecting space to the first and the second channels.

In a first operating position, the regenerator can serve to heat up the exhaust gases before the first catalyst, and the further regenerator can serve to recover the heat of the purified flue gases after the second catalyst. The directional specifications here refer to the flow direction of the exhaust gases. By switching the flow direction, the functions of the regenerators are reversed. In a second operating position, the further regenerator can therefore be used to heat up the exhaust gases before the second catalyst, and the regenerator can be used to recover the heat of the purified flue gases after the first catalyst. As a result, a quasi-continuous operation can be achieved.

To compensate for the losses of the regenerative heat exchange, it is beneficial if the connecting space is connected to a heating device, preferably comprising a gas burner and/or an electric heating device and/or a device for introducing a hot gas flow, to heat up the exhaust gases. Thus, the losses of the heat shift with the regenerators can be compensated by heating the exhaust gases in the connecting space between the first and the second channel by means of the heating device.

In a preferred embodiment, a reducing agent feed is provided for supplying a reducing agent, in particular ammonia, urea, and/or ammonium, into the exhaust gases discharged from the lime shaft kiln, preferably from the PFR kiln, in particular between the regenerator and a first catalyst in the first channel of the cleaning stage and/or between a second catalyst and the further regenerator in the second channel of the cleaning stage.

In a preferred embodiment, the reducing agent feed is connected to a reducing agent supply line, which comprises an evaporator for the reducing agent. In this evaporator, the reducing agent (preferably an aqueous ammonia, ammonium, or urea solution) is sprayed in particular via spray lances into a gas, preferably into exhaust gas recirculated from the cleaning stage, and is preferably vaporized essentially completely. When using urea solution, the urea is decomposed in the process, releasing gaseous ammonia. The evaporator makes it possible to introduce the reducing agent into the cleaning stage in gaseous form and thereby achieve a particularly uniform distribution of the agent.

In a preferred embodiment, an exhaust gas return is provided for returning exhaust gases, in particular from the connecting space between the first and second channels of the cleaning stage, into the supply line for the reducing agent feed. Thus, exhaust gases can also be recirculated via the exhaust gas return and the supply line. In a preferred embodiment, the denitrification catalyst of the cleaning stage can be charged with NH₃ by returning the exhaust gases via the supply line during the charging operating state, in particular at the end of the charging operating state, in order to be able to treat the initially high NOₓ load as effectively as possible at the beginning of the first or second operating state.

In a preferred embodiment, the method also comprises the following steps:
pre-evaporating a reducing agent, in particular ammonia, urea, and/or ammonium, by means of an evaporator in a reducing agent supply line,
supplying the reducing agent into the cleaning stage, and
returning cleaned exhaust gases into the reducing agent supply line, preferably during the charging operating state.

As is known from the prior art, the PFR kiln preferably comprises the following:
a first and/or second fuel supply device for supplying fuel to the first and/or second kiln shaft,
a first and/or second combustion air supply device for supplying combustion air to the first and/or second kiln shaft,
a first and/or second exhaust gas discharge device for discharging the exhaust gas from the first and/or second kiln shaft into the exhaust gas discharge,
a first and/or second cooling air supply device for supplying cooling air to the cooling zone of the first and/or second kiln shaft.

In a preferred embodiment, a kiln filter is provided in the exhaust gas discharge between the lime shaft kiln, preferably the PFR kiln, and the cleaning stage to filter the exhaust gases discharged from the lime shaft kiln, preferably from the PFR kiln. After the kiln filter, a gas conveying device, in particular a fan, can be provided in the discharge line. The bypass line described above can be branched off after the gas conveying device. After the bypass line is branched off, the inlet line to the cleaning stage can join. A further gas conveying device, in particular another fan, can be provided in the outlet line after the cleaning stage. The outlet line merges with the bypass line to the stack line, which leads to the stack.

Compared to EP 3 631 329 B1, the advantage of the above-described embodiment is the retrofittability while continuing to use the existing kiln filter. Such a filter for dedusting the exhaust gas is already a worldwide standard for lime shaft kilns and is thus an integral component of the existing exhaust gas cleaning. Because EP 3 631 329 B1 uses a catalytic filter, the existing filter in this known method cannot continue to be used but instead must be replaced.

### BRIEF DESCRIPTION OF THE FIGURE

The FIGURE shows an embodiment of a plant according to the invention for burning calcium carbonate to calcium oxide.

### DETAILED DESCRIPTION

The FIGURE shows a plant 1 for burning calcium carbonate (limestone) to calcium oxide (quicklime). The plant 1 comprises a parallel flow regenerative (PFR) kiln 2 with a first kiln shaft 3 and a second kiln shaft 4. Depending on the embodiment, additional kiln shafts can also be provided (not shown), which are designed in the same way as the first 3 or second kiln shaft 4. The first kiln shaft 3 and the second kiln shaft 4 can be operated in time sequence as a burning shaft for burning raw material—in this case a limestone bed—and as a preheating shaft for preheating such raw material. Thus, the PFR kiln 2 is switched with a certain frequency between a first operating state, in which the first kiln shaft 3 is operated as a burning shaft and the second kiln shaft 4 as a preheating shaft, and a second operating state, in which the second kiln shaft 4 is operated as a burning shaft and the first kiln shaft 3 as a preheating shaft. The PFR kiln 2 comprises an exhaust gas crossover channel 5 that connects the first kiln shaft 3 to the second kiln shaft 4, so that exhaust gases can be transferred from the burning shaft to the preheating shaft. Raw material is fed into the upper areas of the first 3 or second kiln shaft 4 of the PFR kiln 2. The fully burned material is withdrawn in the lower areas of the first 3 or second kiln shaft 4. In order to achieve the burning of the raw material, fuel is supplied to the first 3 or second kiln shaft 4. In addition, combustion air is introduced from above into the first 3 or second kiln shaft 4. Cooling air is introduced from below into the first 3 or second kiln shaft 4 in order to cool the quicklime.

In the respective burning shaft, a preheating zone, a burning zone, and a cooling zone form from top to bottom. The combustion air flows through the burning shaft from top to bottom and thus in co-current with the raw material. The exhaust gases of the burning shaft are routed via the crossover channel 5 into the preheating shaft, in which the exhaust gases flow from bottom to top and thus in counter-current to the raw material. In the process, the raw material in the preheating shaft is preheated for the next burning operation. After flowing through the raw material in the preheating shaft, the exhaust gases are drawn off from the PFR kiln 2 via a discharge line 6. Once the specified time interval has elapsed, the operating state of the PFR kiln 2 is changed. For this purpose, the combustion air and fuel supply to the kiln shaft previously operated as a burning shaft is interrupted, while the combustion air and fuel supply to the kiln shaft previously operated as a preheating shaft is activated. For example, switching between the first and second operating states can occur every 10 to 15 minutes (min).

Between operation of the plant 1 in the first and second operating states, i.e., between two burning operations, at least one of the first kiln shaft 3 and the second kiln shaft 4 is charged with raw material via a raw material feeding device (not shown). This charging operating state can last, for example, 30 to 40 seconds(s).

As can be seen from the FIGURE, the exhaust gas is discharged via the second kiln shaft 4 (in the first operating state of the PFR kiln 2) or via the first kiln shaft 3 (in the second operating state of the PFR kiln 2) into the discharge line 6. In the discharge line 6, the exhaust gas flows via an openable shut-off device 7A, in particular a damper, into a kiln filter 8, which in the shown embodiment can, for example, comprise at least a bag filter. The kiln filter 8 can reduce the dust content of the exhaust gases. In the embodiment shown, the exhaust gases are drawn away from the PFR kiln 2 by a gas conveying device 9, in particular a fan, along the discharge line 6. The gas conveying device 9 can be arranged immediately after the kiln filter 8. In this disclosure, “upstream” and “downstream” always refer to the flow direction of the exhaust gases from the PFR kiln 2.

As can also be seen from the FIGURE, the discharge line 6 branches downstream of the gas conveying device 9 into a cleaning-stage inlet line 10 and a bypass line 11. The cleaning-stage inlet line 10 leads via another openable shut-off device 7B to an exhaust gas cleaning stage 12, which is described in more detail below. The bypass line 11 runs parallel to the exhaust gas cleaning stage 12, so that in a bypass mode the exhaust gas routed selectively via the bypass line 11 does not pass through the cleaning stage 12. The bypass line 11 rejoins with a cleaning-stage outlet line 14 carrying exhaust gas away from the exhaust gas cleaning stage 12 to form a stack line 13, by which the exhaust gases are routed to a stack 15. Another openable shut-off device 7C, in particular a damper, is arranged in the bypass line 11 so that the flow through the bypass line 11 can be shut off. Another openable shut-off device 7D, in particular a damper, is arranged in the cleaning-stage outlet line 14, with which the exhaust gas flow can be selectively opened or shut off. In the illustrated embodiment, the further openable shut-off device 7D in the cleaning-stage outlet line 14 is arranged downstream of another gas conveying device 17, in particular a fan. Depending on the embodiment, only one of the two gas conveying devices 9, 17 or both gas conveying devices 9, 17 can be provided.

As can be seen from the FIGURE, the exhaust gas cleaning stage 12 comprises at least one regenerator 18 and another regenerator 19, which are each configured for regenerative heat exchange with the exhaust gases from the PFR kiln 2. By means of the regenerative heat exchange, any fluctuations in the temperature of the exhaust gases from the PFR kiln 2 occurring in operation can be buffered, i.e., at least partially compensated.

In the exemplary embodiment of the FIGURE, the cleaning stage 12 comprises a first channel 20 with the regenerator 18 and a second channel 22 with the further regenerator 19, which are connected via a connecting space 23, here designed as a head space. The first channel 20 and the second channel 22 are preferably arranged in parallel. In the example shown, the first channel 20 and the second channel 22 each extend vertically. The connecting space 23 extends transversely to the first channel 20 and the second channel 22. In the example shown, the connecting space 23 extends horizontally. Furthermore, a control system 24 with control elements 24A, in particular valves (preferably poppet valves) or dampers, is provided for alternating flow direction through the cleaning stage 12.

In a first switching state of the control system 24, the exhaust gas flows from the first channel 20 via the connecting space 23 into the second channel 22. In the process, the regenerator 18 heats up the exhaust gas, while the regenerator 18 cools down. The further regenerator 19 cools the exhaust gas, while the second regenerator 19 heats up. In a second switching state of the control system 24, the exhaust gas flows from the second channel 22 via the connecting space 23 into the first channel 20. In the process, the further regenerator 19 heats up the exhaust gas, while the further regenerator 19 cools down. The regenerator 18 cools the exhaust gas, while the regenerator 18 heats up. The direction of flow through the cleaning stage 12 is reversed periodically by means of the control system 24.

In the exemplary embodiment of the FIGURE, the connecting space 23 is connected to a heating device 21, preferably a gas burner and/or an electric heating device, for heating the exhaust gas between the first channel 20 and the second channel 22. Using the heating device 21, the losses of the regenerative heat exchange of the exhaust gas with the regenerator 18 and with the further regenerator 19 can be compensated.

In the exemplary embodiment of the FIGURE, the exhaust gas cleaning stage 12 is designed as an SCR (selective catalytic reduction) unit, with which the nitrogen oxides contained in the exhaust gas can be decomposed by selective catalytic denitrification. For this purpose, in the first channel 20 a first denitrification catalyst 25A is provided, and in the second channel 22 a second denitrification catalyst 25B is provided. A reducing agent feed 26 supplies a reducing agent, in particular ammonia, urea, and/or ammonium, into the cleaning stage 12, selectively at a first point between the first catalyst 24 and the regenerator 18 in the first channel 20, and/or at a second point between the second catalyst 25 and the further regenerator 19 in the second channel 22. The reducing agent feed 26 is connected to a reducing agent supply line 27, in which an evaporator 28 for the reducing agent is arranged for evaporating the reducing agent before introducing it into the exhaust gas. The flow through the reducing agent supply line 27 is accomplished by another gas conveying device 16.

In the charging operating state, i.e., when charging the PFR kiln 2 with raw material, at least part of the exhaust gas (preferably the entire exhaust gas flow) is recirculated from the clean gas side back to the raw gas side, so that the exhaust gas already cleaned by the cleaning stage 12 flows through the cleaning stage 12 again. In the charging operating state, therefore, a circulating flow of the cleaned exhaust gas is provided through the cleaning stage 12.

For this purpose, at least one recirculation line 29, is provided for recirculating at least part of the exhaust gas from the clean gas side to the raw gas side of the cleaning stage 12.

In a first embodiment variant, the bypass line 11 serves as the first recirculation line 29A, which is already present in conventional plants but only used there to bypass the cleaning stage 12. In the design shown here, this bypass line 11 can now be used to route the exhaust gases after passing through the cleaning stage 12 back into the cleaning-stage inlet line 10 via the bypass line 11. In this recirculation mode, the exhaust gases flow in the opposite direction through the bypass line 11 as in the bypass mode, in which the exhaust gases are routed from the discharge line directly to the stack 15 past the cleaning stage 12 during, for example, start-up of the cleaning stage 12.

In another embodiment variant, an optional second recirculation line 29B with another gas conveying device 29C does not branch off from the end of the cleaning-stage outlet line 14, but from an initial or middle section of the cleaning-stage outlet line 14, and leads into a middle or end section of the cleaning-stage inlet line 10. In the illustrated embodiment, the second recirculation line 29B branches off upstream of the gas conveying device 17 in the cleaning-stage outlet line 14 and reenters the cleaning-stage inlet line 10 downstream of the openable shut-off device 7B. This second recirculation line 29B is not present in conventional plants.

As shown in the FIGURE, there may also be an exhaust gas return 30 for returning exhaust gases from the connecting space 23 between the first 20 and the second channel 22 of the cleaning stage 12 into the supply line 27 for the reducing agent feed 26.

The invention has been described above with reference to a PFR kiln, but it can also be used in other types of lime shaft kilns. The lime shaft kiln is designed for discontinuous filling or charging, in which the carbonate rock is fed batch by batch. For this purpose, the lime shaft kiln comprises at least one stationary kiln shaft for burning carbonate rock, wherein the stationary kiln shaft does not move during the burning operation. Preferably, the lime shaft kiln comprises several such kiln shafts. Due to the discontinuous mode of operation, a renewed heating process of the carbonate rock takes place with each new batch, which, among other things, can be reflected in a periodically varying exhaust gas temperature and periodically varying exhaust gas values. The temperature fluctuations are buffered by the invention.

### REFERENCE NUMBERS

1 Plant
2 PFR kiln
3 First kiln shaft
4 Second kiln shaft
5 Crossover channel
6 Discharge line
7A-D Openable shut-off devices
8 Kiln filter
9 Gas conveying device upstream of the branch of the bypass line
10 Cleaning-stage inlet line
11 Bypass line
12 Cleaning stage
13 Stack line
14 Cleaning-stage outlet line
15 Stack
16 Gas conveying device in the supply line
17 Gas conveying device in the outlet line
18 Regenerator
19 Further regenerator
20 First channel
21 Heating device
22 Second channel
23 Connecting space
24 Control system
24A Valves
25A First denitrification catalyst
25B Second denitrification catalyst
26 Reducing agent feed
27 Reducing agent supply line
28 Evaporator
29 Recirculation line
29A First recirculation line
29B Second recirculation line
29C Gas conveying device in the second recirculation line
30 Exhaust gas return

1. A plant for burning carbonate rock, comprising:
a lime shaft kiln with at least one first kiln shaft and one second kiln shaft, which can be operated alternately as a burning shaft for burning raw material and as a preheating shaft for preheating raw material, and with a crossover channel between the first and the second kiln shaft, via which exhaust gases can be transferred from the burning shaft to the preheating shaft,
an exhaust gas discharge for discharging exhaust gases from the lime shaft kiln, and
an exhaust gas cleaning stage for cleaning the exhaust gases discharged from the lime shaft kiln,
wherein the exhaust gas cleaning stage for buffering fluctuations in the temperature of the exhaust gases from the lime shaft kiln comprises at least one regenerator for regenerative heat exchange with the exhaust gases discharged from the lime shaft kiln.

2. The plant according to claim 1, further comprising at least one recirculation line for recirculating at least part of the exhaust gases from the clean gas side to the raw gas side of the cleaning stage.

3. The plant according to claim 2, wherein a bypass line for bypassing the cleaning stages provided as the recirculation line, wherein the bypass line is branched off from the exhaust gas discharge and returned into a stack line upstream of a stack for discharging the exhaust gases into the surroundings of the plant.

4. The plant according to claim 2, wherein the recirculation line is routed from an outlet of the cleaning stage back to an inlet of the cleaning stage.

5. The plant according to claim 1, wherein the cleaning stage comprises a first channel with the regenerator, a connecting space, a second channel with a further regenerator, and a control system configured to alternate a direction of flow through the cleaning stage.

6. The plant according to claim 5, wherein the connecting space is connected to a heating device and/or a device for introducing a hot gas flow, for heating the exhaust gases.

7. The plant according to claim 1, wherein the cleaning stage comprises an SCR (selective catalytic reduction) unit and/or an RTO (regenerative thermal oxidation) unit and/or an RCO (regenerative catalytic oxidation) unit.

8. The plant according to claim 1, further comprising a reducing agent feed for supplying a reducing agent into the exhaust gases discharged from the lime shaft kiln.

9. The plant according to claim 8, wherein the reducing agent feed is connected to a reducing agent supply line, which comprises an evaporator for the reducing agent.

10. The plant according to claim 9, further comprising an exhaust gas return for returning exhaust gases into the supply line for the reducing agent feed.

11. The plant according to claim 1, further comprising a kiln filter in the exhaust gas discharge between the lime shaft kiln and the cleaning stage for filtering the exhaust gases discharged from the lime shaft kiln.

12. A method for burning carbonate rock, having the steps:
operating a parallel flow regenerative (PFR) kiln in a first operating state, in which raw material is burned in a first kiln shaft of the PFR kiln and raw material is preheated in a second kiln shaft of the PFR kiln, wherein exhaust gases are transferred from the first kiln shaft to the second kiln shaft,
operating the PFR kiln in a second operating state, in which raw material is burned in the second kiln shaft and raw material is preheated in the first kiln shaft, wherein exhaust gases are transferred from the second kiln shaft to the first kiln shaft,
discharging exhaust gases from the PFR kiln,
cleaning the exhaust gases discharged from the PFR kiln with a cleaning stage,
wherein regenerative heat exchange occurs between the exhaust gases discharged from the PFR kiln and a regenerator, whereby temperature fluctuations of the exhaust gases discharged from the PFR kiln occurring in the first operating state and/or second operating state of the PFR kiln are buffered.

13. The method according to claim 12, further comprising:
operating the PFR kiln in a charging operating state, in which the first kiln shaft and/or the second kiln shaft is charged with raw material, wherein the volume flow of the exhaust gases discharged from the PFR kiln into the cleaning stage is at least reduced during the charging operating state.

14. The method according to claim 12, further comprising:
recirculating at least part of the exhaust gases from the clean gas side to the raw gas side of the cleaning stage.

15. The method according to claim 12, further comprising:
pre-evaporating a reducing agent with an evaporator in a reducing agent supply line,
supplying the reducing agent into the cleaning stage, and
returning cleaned exhaust gases into the reducing agent supply line.

16. A method for burning carbonate rock, having the steps:
operating a lime shaft kiln with at least one kiln shaft, in which raw material is burned,
discharging exhaust gases from the lime shaft kiln,
cleaning the exhaust gases discharged from the lime shaft kiln by a cleaning stage,
wherein regenerative heat exchange occurs between the exhaust gases discharged from the lime shaft kiln and a regenerator, whereby temperature fluctuations of the exhaust gases discharged from the lime shaft kiln are buffered.

17. The plant according to claim 1, wherein the carbonate rock is limestone, and wherein burning the carbonate rock comprises burning the limestone to form quicklime.

18. The plant according to claim 1, wherein the lime shaft kiln is a parallel flow regenerative (PFR) kiln.

19. The plant according to claim 2, wherein the at least one recirculation line recirculates at least part of the exhaust gases from the clean gas side to the raw gas side of the cleaning stage in a charging operating state when charging the first kiln shaft and/or the second kiln shaft with raw material.

20. The plant according to claim 5, wherein the connecting space is a head space.
